(19) United States
(12) Patent Application Publication
(10) Pub. No.: US 2009/0088132 A1
(43) Pub. Date: Apr. 2, 2009

(54) DETECTING UNAUTHORIZED WIRELESS ACCESS POINTS

(76) Inventor: Timothy J. Politowicz, Great Meadows, NJ (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 11/863,476

(22) Filed: Sep. 28, 2007

(51) Int. Cl. H04M 1/66

(52) U.S. Cl. 455/411

(57) ABSTRACT

An exemplary method of monitoring unauthorized use of wireless communications within a selected location in which a plurality of communication devices conduct authorized communications through an authorized network includes detecting any unauthorized wireless access points using at least one of the communication devices that is also configured as a sensor for detecting any unauthorized wireless access points within a range of the at least one communication device. An indication of a detected unauthorized wireless access point is provided by the at least one communication device. An approximate location of the detected unauthorized wireless access point is determined based on an identification of the at least one communication device and information regarding a location of the at least one communication device.

### FIELD OF THE INVENTION

This invention generally relates to communication. More particularly, this invention relates to wireless communications.

### DESCRIPTION OF THE RELATED ART

Wireless and wireline communication systems are well known and in widespread use. There are a variety of challenges associated with facilitating secure and reliable communications. One such challenge is associated with the development of wireless access point and local area wireless network devices (e.g., Wi-Fi devices). It is now possible for consumers to purchase equipment to set up a local area wireless network or a wireless access point within a house or business location, for example. While such devices are useful for expanding wireless communication capabilities, they can introduce certain difficulties.

For example, when such a device is improperly installed or maintained, it may be vulnerable to unauthorized use. This can pose a security problem for businesses or governmental agencies if the wireless access point provides an avenue to access a network or confidential information, for example. Additionally, such devices could be installed in an attempt to utilize communication resources in an unauthorized manner.

It has become necessary to perform wireless network audits to attempt to locate any unauthorized use of wireless communications including wireless access points that could be used in an unauthorized manner. Auditing existing network resources allows for ensuring that appropriate security settings are functioning as desired on authorized equipment and ensuring that no unauthorized equipment is functioning within an unauthorized location.

Previous approaches to wireless network audits are less than ideal. One approach is to take a specialized device that is capable of detecting wireless access points and drive or walk through a particular location in an attempt to locate any unauthorized or improperly functioning wireless access points. When one is located, the auditing device may use global positioning system information to estimate a location of the located wireless access point.

The time, effort, expertise and resources required for such an audit can be prohibitive. Additionally, this approach only provides audit information when it is being performed. It does not readily facilitate any continuous or on-going auditing capability. These shortcomings leave communication networks undesirably vulnerable to possible intrusion or misuse and there is a need for an improved approach to performing wireless communication audits.

### SUMMARY

An exemplary method of monitoring unauthorized use of wireless communications within a selected location in which a plurality of communication devices conduct authorized communications through an authorized network includes detecting any unauthorized wireless access points using at least one of the communication devices that is also configured as a sensor for detecting any unauthorized wireless access points within a range of the at least one communication device. An indication of a detected unauthorized wireless access point is provided by the communication device. An approximate location of the detected unauthorized wireless access point is determined based on an identification of the communication device and information regarding a location of the communication device.

An exemplary system for monitoring unauthorized use of wireless communications includes a plurality of communication devices configured to perform authorized communications through an authorized network. At least one of the communication devices is also configured as a sensor for detecting any unauthorized wireless access points within a range of the at least one communication device. A server is in communication with the communication device for receiving an indication of a detected unauthorized wireless access point from the communication device. The server determines an approximate location of the detected unauthorized wireless access point based on an identification of the communication device and information regarding a location of the communication device

The various features and advantages of this invention will become apparent to those skilled in the art from the following detailed description. The drawings that accompany the detailed description can be briefly described as follows.

### BRIEF DESCRIPTION OF THE DRAWING

FIG. 1 schematically illustrates selected portions of a wireless communication system that is useful with an embodiment of this invention.

FIG. 2 is a flow chart diagram summarizing an example approach used with an embodiment of this invention.

### DETAILED DESCRIPTION

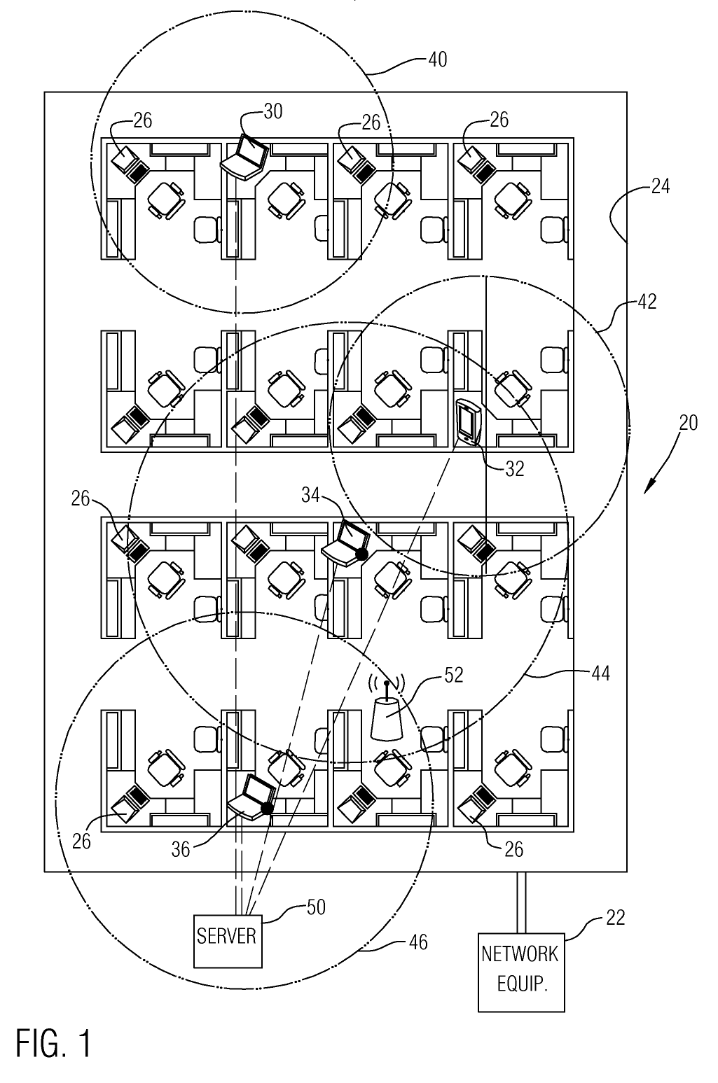

FIG. 1 schematically illustrates selected portions of a communication system 20. This example includes network equipment 22 that establishes an authorized communication network to facilitate communications from within a selected area 24. In this example, the area 24 comprises a floor within a building that is used for business or government purposes, for example. The area 24 includes a plurality of communication devices 26 located within respective workstations or offices. Each of the plurality of communication devices 26 is configured to conduct authorized communications through the authorized network. In one example, at least some of the devices 26 communicate through the authorized network using hard wired communication links between the devices 26 and the network equipment 22. In another example, at least some of the devices 26 use wireless links between the devices 26 and the network equipment 22 for authorized communications from within the area 24.

At least one of the plurality of communication devices 26 is also configured to operate as a sensor for detecting unauthorized wireless communication access points (WAPs) within a range of that device. The illustrated example includes a selected plurality of communication devices 30, 32, 34 and 36 from among the plurality of communication devices in the area 24 that are used for authorized communications through the network equipment 22. The devices 30, 32, 34 and 36 are also configured as sensors for detecting unauthorized WAPs within the area 24. In the illustrated example, the communication device 30 has a range 40 within which it is capable of detecting any active WAPs. Similarly, the device 42 has a detecting range schematically shown at 42, the device 34 has an associated range 44 and the device 36 has a corresponding range 46.

Each of the devices 30, 32, 34 and 36 has wireless communication capabilities (e.g., a wireless access card) that facilitate detecting any unauthorized WAPs within the corresponding range of the device. In one example, known techniques for detecting a WAP are used. For example, the devices 30-36 scan the area within their respective ranges to detect WAP beacon packets or signals on one or more frequencies. In some examples, no WAPs are authorized within a range of one of the devices. In such circumstances, any detected WAP will be considered unauthorized. In other examples, some WAPs may be authorized within a selected area and information regarding a detected WAP (e.g., information from the detected WAP beacon signal) provides an indication of whether the detected WAP is authorized. A WAP may be considered unauthorized for purposes of this description when it is installed in an authorized location or is operating differently than a WAP is expected or required to operate at a particular location (e.g., a WAP that was not properly installed, was tampered with or is not providing appropriate security or control over access to the WAP).

Each of the devices 30, 32, 34 and 36 also has a software module or dedicated processor resources to facilitate reporting any detected unauthorized WAPs to a detection server 50. In one example, the server 50 is located relatively near the area 24 while in another example, the server 50 is located remote from the area 24 at a central processing facility.

In some examples, the devices 30-36 continuously scan for WAPs and provide corresponding reports to the server 50 whenever the devices 30-36 are enabled for communicating with the network equipment 22 (e.g., turned on and in communication with the network). In other examples, the devices 30-36 attempt to detect WAPs responsive to a request from the server 50. The latter approach may save power, for example, and is controllable by setting appropriate timing controls within the server.

In the example of FIG. 1, the communication devices 34 and 36 each detect an unauthorized WAP 52. The server 50 receives an indication or report from each of the devices 34 and 36 regarding the WAP 52. The server 50 in one example is configured to determine whether the detected WAP 52 is expected to be available to the devices 34 and 36. If the detected WAP 52 is not expected, the server 50 determines that the WAP 52 is unauthorized. The server 50 is also configured to determine whether the detected WAP 52 is operating in an expected or required manner if it is expected to be accessible to the devices 34 and 36. In one example, the server 50 is configured to determine whether device parameters such as the service set identifier (SSID), the basic service set identifier (BSSID), the MAC address, a security setting or a combination of these fits within selected criteria that have been predetermined for a particular location. If not, the WAP 52 is considered an unauthorized WAP.

In one example, the server 50 provides an indication of a detected unauthorized WAP to an appropriate individual or entity. In one example, the server 50 also provides an indication of at least an approximate location of the detected WAP 52 based on an identification of the communication devices 34 and 36 and information regarding their locations.

In some examples, the communication devices that are configured as sensors for detecting unauthorized WAPs have global positioning system (GPS) capabilities. Such communication devices provide an indication of current GPS coordinates and the server 50 uses those with knowledge regarding the corresponding detecting range of the device for determining the approximate location of the WAP 52.

In some examples, the communication devices that are configured as sensors have a protocol address (e.g., an Internet Protocol address or a Dynamic Host Configuration Protocol address) that provides an indication of a location of the device. For example a business may establish a known series of network address at various locations and the server 50 utilizes such information to determine the location of the communication device acting as the sensor and the detected WAP.

Another approach includes using information regarding a location of the network equipment 22 (e.g., a router, switch or access point) that is directly serving the communication device acting as the sensor providing the indication of the detected WAP. In the example of FIG. 1, it can be known which of the devices 30-36 is assigned to a particular port on a given switch in a given wiring closet at a known location within a building that includes the area 24. That information or some selected portion of it provides an indication of the WAP location.

Given this description, those skilled in the art will realize how to configure a server 50 to utilize such information that indicates an approximate location and to provide a report or an indication of the detected WAP and its approximate location that meets their particular needs.

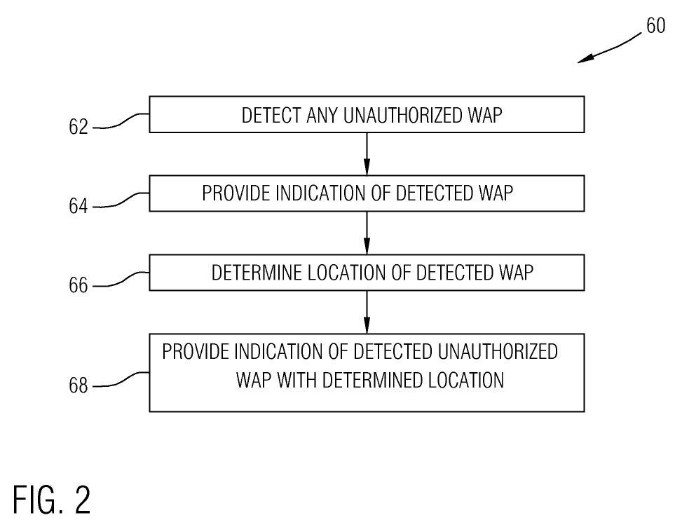

FIG. 2 includes a flow chart diagram 60 that summarizes one example approach. Detecting any unauthorized wireless access points using at least one of the communication devices 30-36 that is configured as a sensor for detecting any unauthorized WAPs within a range of the at least one communication device is shown at 62. An indication of a detected unauthorized WAP is provided by the at least one communication device at 64. An approximate location of the detected unauthorized WAP is determined at 66 based on an identification of the at least one communication device and information regarding a location of the at least one communication device. At 68 a report or indication regarding the detected WAP is provided by the server 50.

One of the features of the disclosed examples that they leverage existing hardware that is already used for authorized communications for the additional purpose of auditing a selected area to detect any unauthorized WAPs. This feature reduces the time and expense required to perform an audit. This feature also allows for continuous or periodic monitoring as needed.

Another feature of the disclosed examples is the ability to determine the status at a variety of locations simultaneously. The disclosed examples also provide the ability to determine whether any WAPs are deployed in an area of interest, whether any deployed WAPs are secured (e.g., functioning properly according to a security policy) or both.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A system for monitoring unauthorized use of wireless communications, comprising:
a plurality of communication devices configured to perform authorized communications through an authorized network, at least one of the communication devices also being configured as a sensor for detecting any unauthorized wireless access points within a range of the at least one communication device;
a server in communication with the at least one communication device for receiving an indication of a detected unauthorized wireless access point from the at least one communication device, the server determining an approximate location of the detected unauthorized wireless access point based on an identification of the at least one communication device and information regarding a location of the at least one communication device.

2. The system of claim 1, wherein the server determines the approximate location of the detected unauthorized wireless access point from location information provided by the at least one communication device.

3. The system of claim 1, wherein the server determines the approximate location of the detected unauthorized wireless access point from information regarding a location where the at least one communication device is expected to be used for authorized communications through the authorized network.

4. The system of claim 1, wherein the server determines the approximate location of the detected unauthorized wireless access point from information regarding a location of authorized network equipment accessed by the at least one communication device.

5. The system of claim 1, wherein the server determines the approximate location of the detected unauthorized wireless access point from information regarding a selected protocol address of the at least one communication device.

6. The system of claim 1, wherein the at least one communication device operates to detect any unauthorized wireless access points whenever the at least one communication device is enabled to perform authorized communications through the authorized network.

7. The system of claim 1, wherein the at least one communication device operates to detect any unauthorized wireless access points responsive to a corresponding request from the server.

8. The system of claim 1, wherein a selected plurality of the plurality of communication devices are each configured as a sensor for detecting any unauthorized wireless access points and wherein the selected plurality of communication devices are positioned relative to each other to provide a desired range of detecting coverage within the selected location.

9. The system of claim 1, wherein the at least one communication device communicates with the authorized network over a hard wired connection.

10. The system of claim 1, wherein the at least one communication device communicates with the authorized network using a wireless link associated with the authorized network.

11. A method of monitoring unauthorized use of wireless communications within a selected location in which a plurality of communication devices conduct authorized communications through an authorized network, comprising the steps of:
detecting any unauthorized wireless access points using at least one of the communication devices that is also configured as a sensor for detecting any unauthorized wireless access points within a range of the at least one communication device;
providing an indication of a detected unauthorized wireless access point from the at least one communication device;
determining an approximate location of the detected unauthorized wireless access point based on an identification of the at least one communication device and information regarding a location of the at least one communication device.

12. The method of claim 11, comprising
determining the approximate location of the detected unauthorized wireless access point from location information provided by the at least one communication device.

13. The method of claim 11, comprising
determining the approximate location of the detected unauthorized wireless access point from information regarding a location where the at least one communication device is expected to be used for authorized communications through the authorized network.

14. The method of claim 11, comprising
determining the approximate location of the detected unauthorized wireless access point from information regarding a location of authorized network equipment accessed by the at least one communication device.

15. The method of claim 11, comprising
determining the approximate location of the detected unauthorized wireless access point from information regarding a selected protocol address of the at least one communication device.

16. The method of claim 11, comprising
detecting any unauthorized wireless access points using the at least one communication device whenever the at least one communication device is enabled to perform authorized communications through the authorized network.

17. The method of claim 11, comprising
detecting any unauthorized wireless access points using the at least one communication device responsive to a corresponding request received by the at least one communication device.

18. The method of claim 11, comprising
detecting any unauthorized wireless access points using a selected plurality of the plurality of communication devices that are each configured as a sensor; and
positioning the selected plurality of communication devices relative to each other to provide a desired range of detecting coverage within a selected location.

19. The method of claim 11, comprising
communicating between the at least one communication device and the authorized network over a hard wired connection.

20. The method of claim 11, comprising
communicating between the at least one communication device and the authorized network using a wireless link associated with the authorized network.
